(19) United States
(12) Patent Application Publication
(10) Pub. No.: US 2009/0027508 A1
(43) Pub. Date: Jan. 29, 2009

(54) IMAGE PROCESSING SYSTEM, IMAGING DEVICE, AND OUTPUT DEVICE

(76) Inventors: Takanori Miki, Kanagawa (JP); Masami Haino, Tokyo (JP)

Correspondence Address: Frank Pincelli;Patent Legal Staff, Eastman Kodak Company, 343 State Street, Rochester, NY, 14650-2201, US

(21) Appl. No.: 11/962,157

(22) Filed: Dec. 21, 2007

(30) Foreign Application Priority Data
Jul. 25, 2007 (JP) 2007-192978

(51) Int. Cl. H04N 5/228

(52) U.S. Cl. 348/208.99; 348/207.2; 348/E05.031

(57) ABSTRACT

In a system built from an imaging device and an output device, camera shake compensation is performed while processing load imposed on the imaging device is being lessened. An image processing system is built from a digital camera and a printer. Image data pertaining to a subject are recorded in a recording medium. Further, the amount of blurring of the digital camera is detected by means of a gyroscopic sensor, and PSF data are recorded in the recording medium. The printer is equipped with an image conversion section, a PSF conversion section, and an image restoration section, and a resolution of the image data and a resolution of the PSF data are converted, thereby restoring an original image.

### CROSS REFERENCE TO RELATED APPLICATIONS

This application claims priority to Japanese Patent Application No. 2007-192978 filed on Jul. 25, 2007, which is incorporated herein by reference in its entirety.

### FIELD OF THE INVENTION

The present invention relates to an image processing system, an imaging device used in the system, and an output device, and more particularly to an image restoration technique.

### BACKGROUND OF THE INVENTION

A digital camera is recently equipped with a camera shake compensation mechanism for reducing blurring caused by hand movement (hereinafter often called “camera shake”) during image-capturing operation. Compensation techniques, which are available for the camera shake compensation mechanism, include an electronic camera shake compensation technique. The electronic camera shake compensation technique includes narrowing a photographable area to a given size and reading an image into buffer memory during image-capturing operation, computing the amount of deviation by comparing a first-captured image with a subsequently-captured image, and capturing an image by means of automatically shifting the photographable area and recording the captured image. The technique also includes an optical camera shake compensation technique including incorporating into a lens a correction lens with a built-in vibration gyroscopic mechanism and shifting the correction lens in the direction toward canceling camera shake. Another technique is an image sensor shift camera shake compensation technique including detecting camera shake by means of a vibration gyroscopic mechanism and shifting an image sensor, such as a CCD, CMOS, and the like, in accordance with camera shake, to thus compensate for an optical axis. Further, a technique for compensating for camera shake by means of processing a captured image to restore an original image has also been proposed. A technique using a PSF (Point-Spread Function) showing the amount of camera shake has been known in connection with processing performed after an image-capturing operation.

However, as the number of pixels increases in a digital camera, restoration of an image having a large number of pixels entails a heavy load on a CPU and consumes a great deal of time. Further, using a high-performance CPU leads to an increase in cost and an increase in power consumption.

### SUMMARY OF THE INVENTION

The present invention provides a system and an apparatus which enable a reduction in processing load imposed on a CPU of an imaging device. The present invention also provides high-speed restoration and output of an original image even when an image having an arbitrary number of pixels is captured by means of image-capturing operation of an image capture device, such as a digital camera.

Specifically, the present invention provides an image processing system including an imaging device and an output device. More particularly, the imaging device has a recording section for capturing an image of a subject; and recording the image as first image data and associating blurring occurred during image-capturing operation with the first image data as first movement locus data or recording the first movement locus data in a header of the first image data; and

the system further comprises

an image conversion section which converts a resolution of the first image data in accordance with a resolution of the output device, to thus generate second image data;

a movement locus conversion section which converts a resolution of the first movement locus data in accordance with the resolution of the output device, thereby generating second movement locus data;

image restoration means which generates restored image data by means of compensating for the blurring of the second image data through use of the second movement locus data; and

an output section for outputting the restored image data.

The present invention also provides an imaging device used in an image processing system including an output device, comprising:

a recording section for capturing an image of a subject; and recording the image as first image data and associating blurring occurred during image-capturing operation with the first image data as first movement locus data or recording the first movement locus data in a header of the first image data;

an image conversion section which converts a resolution of the first image data in accordance with a resolution of the output device, to thus generate second image data;

a movement locus conversion section which converts a resolution of the first movement locus data in accordance with the resolution of the output device, thereby generating second movement locus data; and

a section for outputting the second image data and the second movement locus data to the output device, wherein generation of the second image data, generation of the second movement locus data, and processing for supplying the second image data and the second movement locus data are performed in accordance with a request for selecting the first image data and a request for outputting the first image data to the output device.

Moreover, the present invention provides an output device used in an image processing system including an imaging device, comprising:

a section for inputting first image data supplied from the imaging device and first movement locus data corresponding to blurring occurred during image-capturing operation;

an image conversion section which converts a resolution of the first image data in accordance with an output resolution, thereby generating second image data;

a movement locus conversion section which converts a resolution of the first movement locus data in accordance with the output resolution, to thus generate second movement locus data;

an image restoration section which generates restored image data by means of compensating for the blurring of the second image data through use of the second movement locus data; and

an output section for outputting the restored image data.

According to the present invention, an image can be output by means of compensating for camera shake occurred during image-capturing operation while lessening processing load imposed on an imaging device.

The invention will be more clearly comprehended by reference to the embodiments provided below. However, the scope of the invention is not limited to those embodiments.

### BRIEF DESCRIPTION OF THE DRAWINGS

Preferred embodiments of the present invention will be described in detail by reference to the following figures, wherein:

FIG. 1 is a block diagram of an image processing system of an embodiment;

FIG. 2 is a diagrammatic descriptive view of processing of the present embodiment;

FIG. 3 is a flowchart of overall processing of the present embodiment;

FIG. 4 is a flowchart of PSF data conversion processing of the embodiment;

FIG. 5 is a descriptive view of the PSF data; and

FIG. 6 is a descriptive view of conversion (resizing) of the PSF data.

### DETAILED DESCRIPTION OF THE PREFERRED EMBODIMENT

An embodiment of the present invention will be described hereunder by reference to the drawings.

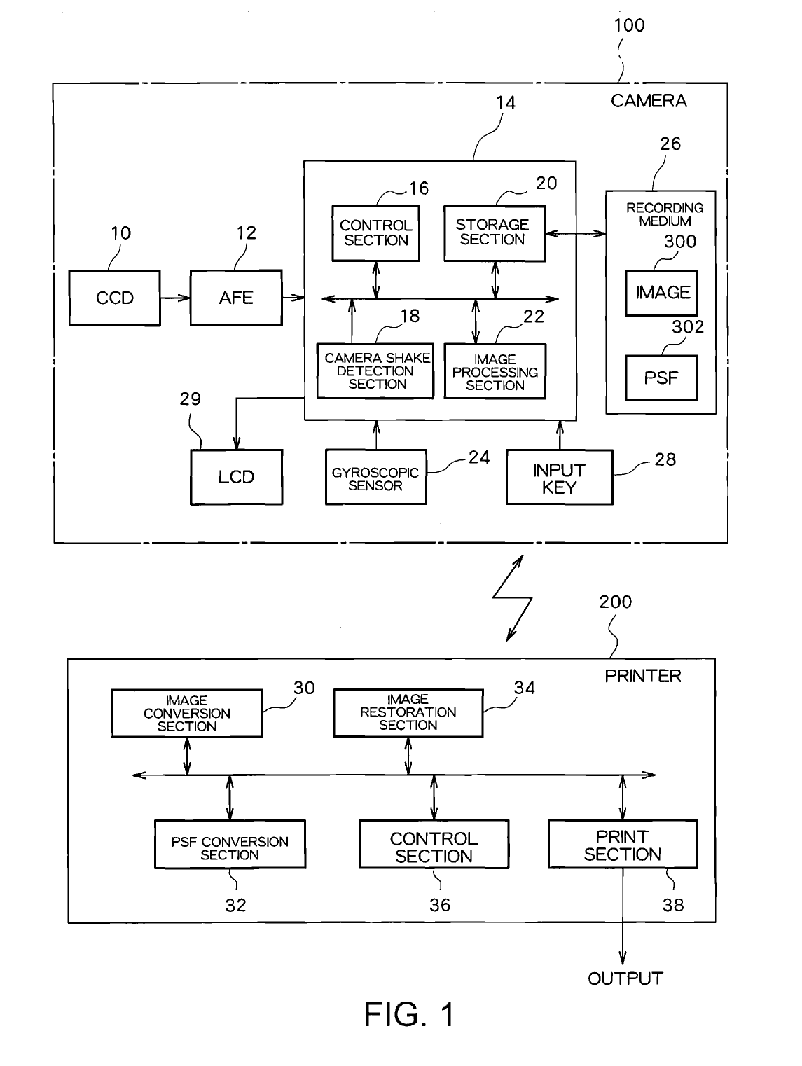

FIG. 1 shows the entire configuration of an image processing system of an embodiment built from a digital camera serving as an imaging device and a printer serving as an output device. In the system of the present embodiment, image data pertaining to a subject captured by a digital camera are recorded, and a locus of movement (hereinafter called a “movement locus”) of the digital camera main body caused by hand movement during image-capturing operation is recorded, as PSF data, in conjunction with the image data in the digital camera. When a user selects image data and prints the selected data by means of the printer, the printer subjects the image data to camera shake compensation by use of the PSF data, to thus restore an original image and print the restored original image. Specifically, the system of the present embodiment is based on the presumption that image data and PSF data are separately recorded in a mutually-associated manner in memory rather than image data captured during image-capturing operation being restored and recorded in the memory of the digital camera, or that a PSF is recorded in an image header and stored in memory. A mode for recording image data in memory without restoration thereof and subjecting the image data to restoration processing in accordance with a command from the user is referred to as post-processing.

In FIG. 1, the system is built from a digital camera 100 and a printer 200. The digital camera 100 and the printer 200 are connected together by means of wired communication or wireless communication. The digital camera 100 and the printer 200 do not need to be positioned in close proximity to each other, and may also be positioned at remote locations and connected together by means of the Internet. The printer 200 may also function as a printer dock and have a function of recharging a built-in battery of the digital camera 100 by use of a power supply circuit of the printer dock while the digital camera 100 is positioned in the printer dock.

The digital camera 100 has a CCD 10, an analogue front-end (AFE) processor 12 for converting an analogue signal to a digital signal, an image processing IC 14, a gyroscopic sensor 24, a recording medium 26, an input key 28, and an LCD 29.

The CCD 10 converts light from the subject into an electric signal and outputs an analogue image signal. An imaging element is not limited to the CCD 10, and CMOS may also be used. The analogue front-end (AFE) 12 subjects an analogue image signal to correlation double sampling, thereby converting an analogue image signal into a digital image signal. The digital image signal is supplied to an image processing IC 14 having, as functional blocks, a control section 16, a camera shake detection section 18, a storage section 20, and an image processing section 22. Operation timing of the CCD 10 and operation timing of the AFE 12 are controlled in accordance with a timing signal from a timing generator.

The image processing section 22 subjects a digital image signal from the AFE 12 to YC separation, and further subjects the YC-separated signal to known image processing, that is, edge enhancement processing, white balance adjustment, color correction processing, and γ correction processing. The image data having undergone image processing are subjected to, e.g., JPEG compression, and stored in the storage section 20. Further, the image data are recorded in an external recording medium 26, such as flash memory. The image data recorded in the recording medium 26 are decoded and displayed on an LCD 29.

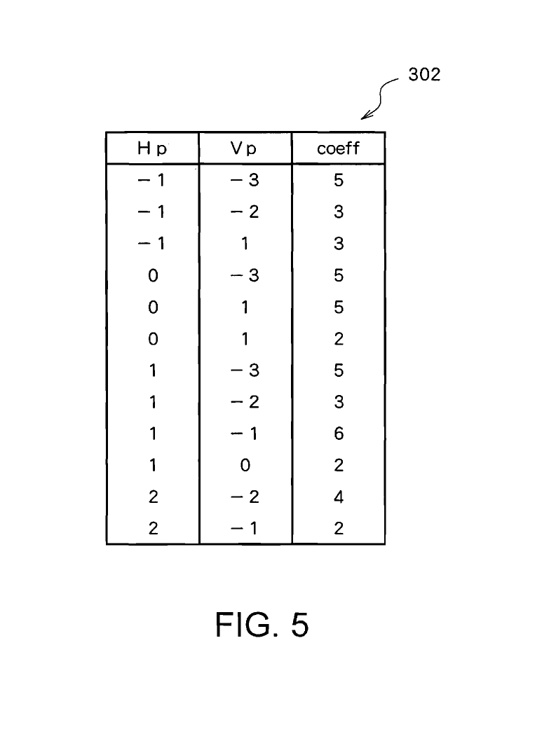

The camera shake detection section 18 detects, from an angular velocity detected by the gyroscopic sensor 24, the amount of camera shake arose during image-capturing operation, and computes a PSF used for image restoration from the amount of camera shake. The PSF is an expression of movement locus of a point light source caused by hand movement as a brightness distribution function for each of pixels of the CCD 10 and is computed from the amount of movement of an image that is derived from angular velocity detected by the gyroscopic sensor 24 and image magnifying power of an imaging system. Specifically, provided that an output from the gyroscopic sensor 24 is ω, a focal length is “f”, a sampling period is Δts, and the movement locus of the point light source on the CCD 10 is (X, Y), an angle of change in a locus X achieved in a minute time Δt is expressed as ω×Δt, and the amount of displacement Δx is expressed as fΔθ. Hence the locus X achieved during an exposure time is computed as X=ΣfΔθ. The same also applies to a locus Y. The movement locus (X, Y) of the point light source can be expressed as a two-dimensional matrix. Values of respective components of the matrix show brightness values (intensity levels) of pixels. When a period of time during which the point light source is present becomes longer, a larger value is shown. FIG. 5 shows example PSFs. Brightness values of the respective pixels can be grasped as weights (coeff) of the respective pixels and expressed as a table of weights coeff achieved at coordinates (Hp, Vp) of the respective pixels. The computed PSF data are stored in the storage section and further stored in a recording medium 26 in conjunction with the image data. As illustrated, the image data 300 and the PSF data 302 are recorded in a pair in the recording medium 26.

After capturing of a subject image, the user selects an image to be printed by use of an input key 28 of the digital camera 100. Selected image data 300 and PSF data 302 associated therewith are transmitted to a printer 200 by means of wired or wireless communication. It should be noted that the PSF data associated with the image data are also automatically transmitted to the printer 200 regardless of the user having selected only the image data.

The printer 200 has an image conversion section 30, a PSF conversion section 32, an image restoration section 34, a control section 36, and a print section 38. In accordance with a difference between the resolution of the digital camera 100 and the resolution of the printer 200, the image conversion section 30 and the PSF conversion section 32 convert the resolution of the image data 300 and the resolution of the PSF data 302 into resolutions conforming to the resolution of the printer 200. Specifically, the image conversion section 30 converts the resolution of the image data 300 into a resolution conforming to the resolution of the print section 38, and the PSF conversion section 32 converts the resolution of the PSF data 302 into a resolution conforming to the resolution of the print section 38.

The image restoration section 34 restores an original image by means of subjecting the image data converted by the image conversion section 30 to camera shake compensation through use of the PSF data converted by the PSF conversion section 32. Camera shake compensation using a PSF includes; for example, a known steepest-descent technique, and the overview of the technique is as follows. Specifically, ∇ J of a captured image is computed, where J denotes the amount of evaluation of a common inverted filter. Provided that a deteriorated image corresponding to a captured image is taken as G, that a restored image is taken as F, and a deterioration function is taken as H, J=∥G−HF∥². The expression means that the amount of evaluation J is given as the magnitude of a difference between an image HF obtained by application of the deterioration function H to the restored image F and an actual deteriorated image G. So long as the restored image is restored properly, HF=G is theoretically attained, and the amount of evaluation comes to zero. The smaller the amount of evaluation J, the better is restored the restored image F. According to the steepest-descent technique, repeated calculation is iterated until the magnitude of ∇J which is a gradient of the amount of evaluation J; namely, a square of norm of ∇J, comes to a threshold value or less, and repeated calculation is terminated at a point in time when the threshold value or less is acquired, whereby the restored image F is obtained. The amount of evaluation J is computed by use of the captured image (the deteriorated image G) and the restored image F as well as use of the PSF; namely, the deterioration function H. A square of norm of the computed ∇J is compared with a threshold value, to thus determine whether or not the square is equal to or less than the threshold value. When the square is equal to or less than the threshold value, the norm of ∇J is deemed to have converged at an optimum solution, and repeated calculation is completed. In the meantime, when the square of norm of ∇J exceeds the threshold value, restoration is considered to be insufficient, and repeated calculation is continued. As a matter of course, the camera shake compensation technique using the PSF is not limited to the steepest-descent technique, and another technique may also be used. The restored original image data are supplied to the print section 38, where the data are printed out. The control section 36 controls operations of individual sections of the printer 200. Consequently, although the image data 300 recorded in the recording medium 26 of the digital camera 100 are blurred image data, an image printed out by the printer 200 is an image undergone camera shake compensation.

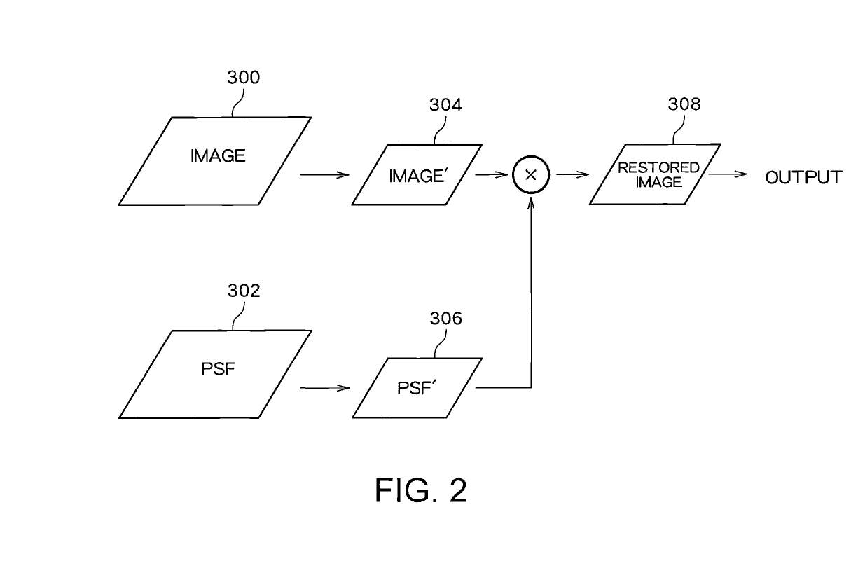

FIG. 2 schematically shows print processing of the present embodiment. In accordance with a print command from the user, the image data 300 and the PSF data 302 associated therewith are transmitted from the digital camera 100 to the printer 200. The resolution of the image data 300 is determined by the number of effective pixels of the CCD 10 of the digital camera 100, and the like. Since the PSF data 302 are expressed as a brightness value or an intensity value of each pixel, the PSF data 302 have the same resolution as that of the image data 300. The image conversion section 30 of the printer 200 converts the resolution of the image data 300 received from the digital camera 100 so as to conform to the resolution of the print section 38, to thus generate image data 304. The resolution of the print section 38 is previously stored in ROM, or the like, of the printer 200. The image conversion section 30 may also retain resolution data. Conversion of the resolution of the image data is known and described in, for example, JP 10-108006 A. When the resolution of the digital camera 100 is higher than the resolution of the print section 38, the image data 300 are converted into a low resolution. In the meantime, since the received PSF data 302 still retain its original resolution, the original image cannot be restored even when the image data 304 are subjected to camera shake compensation by use of the PSF data 302. The reason for this is that pixels corresponding to the image data 304 differ from pixels corresponding to the PSF data 302. Accordingly, the PSF conversion section 32 of the printer 200 converts the resolution of the PSF data 302, to thus generate PSF data 306. Although conversion of the resolution of the PSF data 302 can also be performed by means of an arbitrary technique, conversion is performed by means of; for example, bi-linear filtering using a ratio R of conversion of the resolution of the image data 302. Since the resolution of the image data 304 and the resolution of the PSF data 306 are identical with each other, these sets of data are subjected to camera shake compensation, thereby generating a restored image 308. Although camera shake compensation is schematically shown as multiplication processing in the drawing, camera shake compensation is not limited to multiplication. The restored image 308 is printed by means of the print section 38.

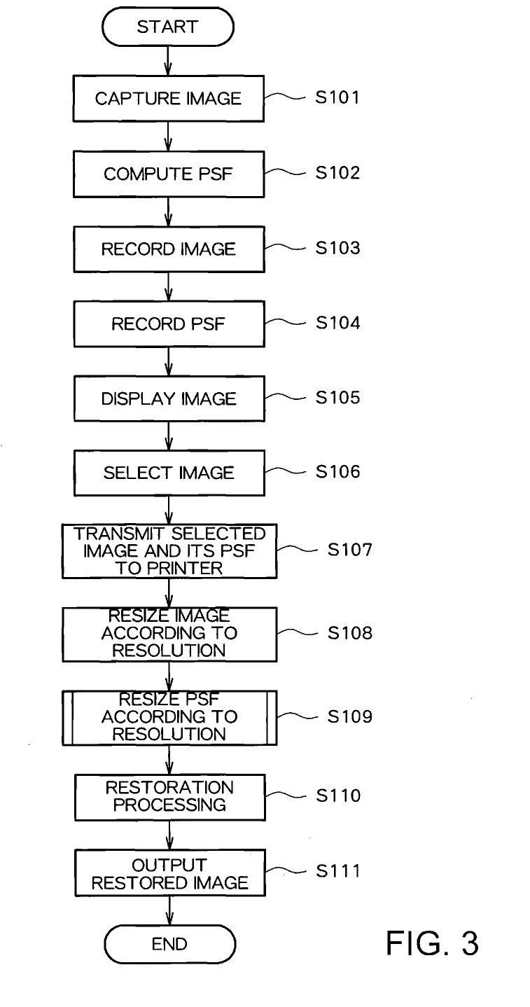

FIG. 3 shows a flowchart of overall processing performed in the present embodiment. First, the digital camera 100 is started to perform exposure control and focusing control, and captures an image of the subject (S101). Depending on the digital camera 100, the resolution of an image to be captured can also be selected. As mentioned previously, the captured image data are subjected to YC separation processing, edge enhancement processing, white balance processing, color correction processing, γ correction processing, and the like. Further, the captured image are subjected to; for example, JPEG compression processing. In the meantime, the amount of camera shake of the digital camera 100 occurred during image-capturing operation is detected by means of the gyroscopic sensor 24, and PSF data corresponding to a movement locus of the point light source on the CCD 10 induced by hand movement are computed (S102). The PSF data are expressed in the form of a table which is a combination of coordinates and weights thereof. The captured image data are recorded as first image data into the recording medium 26 (S103). The computed PSF data are recorded as first movement locust data in the recording medium 26 in conjunction with the image data (S104). An associating technique is arbitrary, and the PSF data are associated as a result of; for example, the PSF data having, as header information, unique identification data for use in specify image data. The image data and the PSF data may also be stored in a single directory or folder, to thus become associated with each other. The user can read captured image data from the recording medium 26 and display the read data on the LCD 29 by means of operating the input key 28, to thus visually ascertain the captured image data. However, at this time, the PSF data do not need to be displayed on the LCD 29. Specifically, the user does not need to recognize the presence of the PSF data.

When the user prints out the image data, the captured image data are displayed on the LCD 29 (S105), and an image to be printed is selected by use of the input key 28 (S106). Printing is commanded by operation of the input key 28. The image data selected and commanded to be printed are transmitted to the printer 200 by way of a communications interface of the digital camera 100. Further, the PSF data associated with the selected image area also transmitted to the printer 200 (S107). The digital camera 100 may also transmit the PSF data simultaneously with the image data or transmit associated PSF data to the printer 200 in accordance with a request signal transmitted from the printer 200 having received the image data after transmitting the image data. The printer 200 receives the image data and the PSF data transmitted from the digital camera 100, and performs print processing.

Prior to print processing, the printer 200 first converts (resizes) the resolution of the received image data so as to conform to the resolution of the print section 38, thereby generating second image data (S108). Provided that the image size of the first image data is taken as Hin×Vin and the resolution of the print section 38 is taken as Hout×Vout, an image size Hin′ and Vin′ of converted (resized) second image are defined as Hin′=Hout and Vin′=Vout. After the second image data have been generated from the first image data by means of conversion of resolution of the image data, the resolution of the received PSF data is converted (resized) so as to conform to the resolution of the print section 38; in other words, the resolution of the second image data, to thus generate the second PSF data (S109).

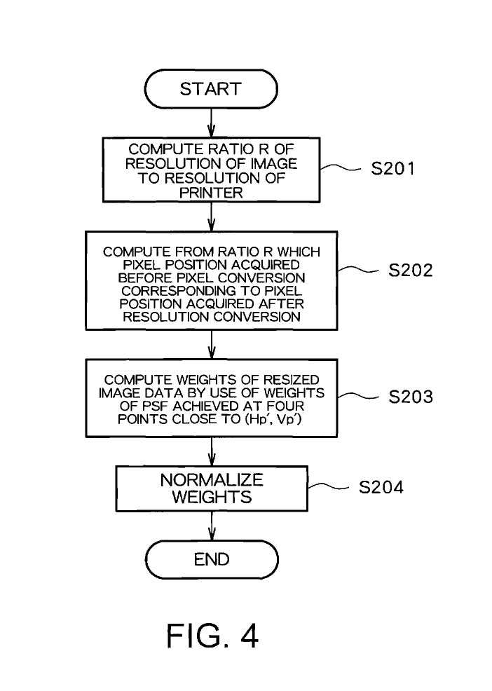

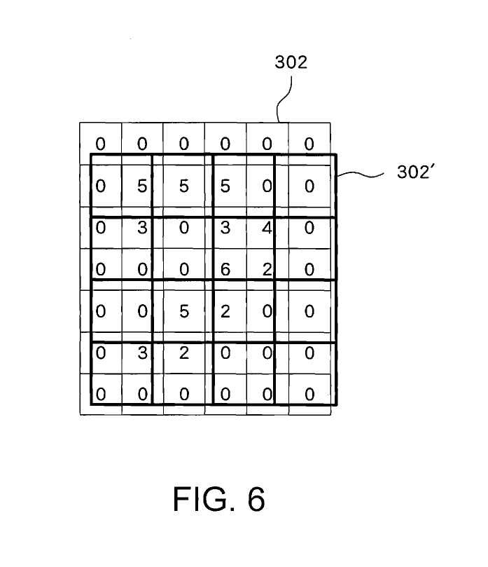

FIG. 4 shows a flowchart of detailed processing pertaining to S109. A ratio R of the resolution of the image data to the resolution of the print section 38 is first computed (S201). A horizontal ratio Rh is Rh=Hout/Hin, and a vertical ratio Rv is Rv=Vout/Vin. The resolution of the first PSF data is converted by use of the ratio R, to thus generate second PSF data. Specifically, on the assumption that the size of the second PSF data is Hp′ and Vp′, we have Hp′=Hp×Rh and Vp′=Vp×Rv. Correspondence between the pixel position of the second PSF data acquired through resolution conversion and any pixel position of the first PSF data having not yet undergone resolution conversion is computed by use of the ratio R (S202). FIG. 5 shows the first PSF data 302 in table form, and FIG. 6 shows expression of the first PSF data 302 (indicated by a narrow line) in a matrix form and expression of the second PSF data 302′ (indicated by a thick line) in a matrix form. A certain pixel position (H′, V′) of the second PSF data 302′ corresponds to H′=H×Rh and V′=V×Rv, and a weight achieved at this pixel position is computed by use of bi-linear filtering (S203). The weight of the pixel position (H′, V′) is specifically computed as an average of weights of four points close to the pixel position. After weights of all of the pixels have been computed through bilinear filtering, the computed weights are normalized (S204).

Turning back to FIG. 3, second image data are generated as mentioned above by means of conversion of the first image data, and the second PSF data are generated by means of conversion of the first PSF data. Subsequently, the second PSF data are applied to the second image data, thereby performing restoration processing (S110). The restored original image is supplied to the print section 38, and the print section 38 prints the image (S111).

As mentioned above, according to the present embodiment, the printer 200 performs all operations; that is, image data conversion, PSF data conversion, and original image conversion. Hence, processing load imposed on the CPU of the digital camera 100 is lessened. Although the user visually ascertains an image blurred by hand movement on the LCD of the digital camera 100, a picture undergone camera shake compensation can be obtained when the image is printed out by the printer 200.

In the present embodiment, as shown in FIG. 1, the printer 200 is equipped with the image conversion section 30, the PSF conversion section 32, and the image restoration section 34. However, it may also be the case where the digital camera 100 will be equipped with the image conversion section 30 and the PSF conversion section 32 and where the printer 200 will be equipped with the image restoration section 34. In this case, the resolution data pertaining to the print section 38 of the printer 200 must be supplied to the image conversion section 30 of the digital camera 100. The resolution data supplied from the printer 200 are recorded in the storage section 20 of the digital camera 100. The image data 300 and the PSF data 302 are recorded in the recording medium 26. When the user selects the image data 300 and commands printing of the image data 300, the image conversion section 30 and the PSF conversion section 32 provided in the digital camera 100 convert image data and PSF data, respectively. Second image data and second PSF data acquired as a result of conversion are supplied to the printer 200. The printer 200 applies the second PSF data to the received second image data, thereby restoring an original image, and the print section 38 prints the original image. Even in this case, resolution conversion processing is performed in the digital camera 100, but restoration processing is performed in the printer 200. Therefore, processing load imposed on the CPU provided in the digital camera 100 can be lessened.

Although the printer 200 is illustrated as an output device in the present embodiment, the output device may also be embodied by a display. In this case, the display is equipped with the image conversion section 30, the PSF conversion section 32, and the image restoration section 34. When the user selects image data to be displayed, the selected image data and PSF data are transmitted from the digital camera 100 to the display. The display received the image data and the PSF data converts the resolution of the image data and the resolution of the PSF data so as to conform to an output resolution, to thus generate second image data and second PSF data. An original image is restored by use of these sets of data, and the restored image is displayed. The display is equipped with the image restoration section 34, and the digital camera 100 may also be equipped with the conversion section 30 and the PSF conversion section 32.

### PARTS LIST

10 CCD
12 AFE processor
14 image processing IC
16 control section
18 camera shake detection section
20 storage section
22 image processing section
24 gyroscopic sensor
26 recording medium
28 input key
29 LCD
30 conversion section
32 PSF conversion section
34 image restoration section
36 control section
38 print section
100 digital camera
200 printer
300 image data
302 PSF data
304 image data
306 PSF data
308 restored image

What is claimed is:

1. An image processing system including an imaging device and an output device, comprising:
an imaging device having a recording section for capturing a first image data of a subject, and recording blurring occurring during the image-capturing operation as first movement locus data in association with the first image data;
an image conversion section that converts a resolution of the first image data in accordance with a resolution of the output device, to generate second image data;
a movement locus conversion section which converts a resolution of the first movement locus data in accordance with the resolution of the output device, generating second movement locus data;
image restoration means which generates restored image data by compensating for the blurring of the second image data using the second movement locus data; and
an output section for outputting the restored image data.

2. The image processing system according to claim 1, wherein the image conversion section, the movement locus conversion section, the image restoration section, and the output section are provided in the output device.

3. The image processing system according to claim 1, wherein the image conversion section and the movement locus conversion section are provided in the imaging device, and the image restoration section and the output section are provided in the output device.

4. The image processing system according to claim 1, wherein the first movement locus data and the second movement locus data correspond to point-spread function (PSF) data.

5. The image processing system according to claim 1, wherein the movement locus conversion section generates the second movement locus data from the first movement locus data by means of bi-liner filtering through use of a ratio of the resolution of the imaging device to the resolution of the output device.

6. An imaging device used in an image processing system including an output device, comprising:
a recording section for capturing an image of a subject; and recording the image as first image data and associating blurring occurred during image-capturing operation with the first image data as first movement locus data or recording the first movement locus data in a header of the first image data;
an image conversion section which converts a resolution of the first image data in accordance with a resolution of the output device, to thus generate second image data;
a movement locus conversion section which converts a resolution of the first movement locus data in accordance with the resolution of the output device, thereby generating second movement locus data; and
a section for outputting the second image data and the second movement locus data to the output device, wherein generation of the second image data, generation of the second movement locus data, and processing for supplying the second image data and the second movement locus data are performed in accordance with a request for selecting the first image data and a request for outputting the first image data to the output device.

7. An output device used in an image processing system including an imaging device, comprising:
a section for inputting first image data supplied from the imaging device and first movement locus data corresponding to blurring occurred during image-capturing operation;
an image conversion section which converts a resolution of the first image data in accordance with an output resolution, thereby generating second image data;
a movement locus conversion section which converts a resolution of the first movement locus data in accordance with the output resolution, to thus generate second movement locus data;
an image restoration section which generates restored image data by means of compensating for the blurring of the second image data through use of the second movement locus data; and
an output section for outputting the restored image data.
